(19) United States
(12) Patent Application Publication
(10) Pub. No.: US 2026/0218065 A1
(43) Pub. Date: Jul. 30, 2026

(54) METHOD FOR PROCESSING LIQUEFIED MATERIALS

(71) Applicant: TOPSOE A/S, Kgs. Lyngby (DK)

(72) Inventors: Stefan ANDERSEN, Kgs. Lyngby (DK); Christian Ejersbo STREBEL, Kgs. Lyngby (DK); Nghia Pham PHU, Kgs. Lyngby (DK); Ole Frej ALKILDE, Kgs. Lyngby (DK); Klas Jerker ANDERSSON, Kgs. Lyngby (DK)

(73) Assignee: TOPSOE A/S, Kgs. Lyngby (DK)

(21) Appl. No.: 19/158,240

(22) PCT Filed: Mar. 8, 2024
(86) PCT No.: PCT/EP2024/056237

§ 371 Date: Aug. 20, 2025

(30) Foreign Application Priority Data
Mar. 10, 2023 (DK) PA202300219
Mar. 10, 2023 (EP) 23161247.4

(51) Int. Cl. C10G 45/34; B01J 38/04

(52) U.S. Cl. CPC C10G 45/34; B01J 38/04; C10G 2300/202; C10G 2300/4093

(57) ABSTRACT

There is provided a process for hydrotreating a liquid oil stream; wherein the liquid oil stream is a thermochemical decomposition oil stream; the process comprising: (i) a hydrotreatment step comprising hydrotreating the liquid oil stream in a fixed bed reactor at a temperature of less than 250° C., wherein the fixed bed reactor comprises a hydrotreatment catalyst; and (ii) an in-situ catalyst regeneration step such that one or more ammonium salts deposited on the hydrotreatment catalyst are removed from the hydrotreatment catalyst, wherein the in-situ catalyst regeneration step comprises heating the hydrotreatment catalyst with a flushing gas, or mixtures or a flushing gas and oil.

### FIELD OF THE INVENTION

The invention relates to the field of hydroprocessing of liquid oils such as pyrolysis oils, more specifically to the stabilization of the liquid oil by hydrotreating prior to being upgraded by further hydroprocessing, such as hydrodeoxygenation (HDO) or hydrodenitrogenation (HDN).

### BACKGROUND OF THE INVENTION

The field of renewable feedstocks has been attracting a great deal of attention, in not only Europe, but also US and China. Using renewable feedstocks enables a sustainable approach to the production of hydrocarbon products boiling in the transportation fuel range, in particular any of diesel, jet fuel and naphtha as well as petrochemicals, such as raw materials for steam crackers and plastic production.

The hydroprocessing of renewable feedstocks is a challenging task, due to the variety and complexity of these feedstocks. Currently, it is normally perceived that there are three generations of renewable feedstocks. The first generation are renewable feedstocks which are already liquid and include virgin oils, such as rapeseed oil and soybean oil. The second generation are waste oil and fats, such as used cooking oils, animal fats and crude tall oil (CTO). The third generation is much larger in volume, i.e. is more available, than for instance the second generation. This third generation includes solid renewable feedstocks which encompasses: i) solid renewable feedstock, such as plastic waste, waste tyres, municipal solid waste, agricultural residue and forestry residue, for instance lignocellulosic biomass such as grass; and ii) low indirect land-use change (ILUC) crops such as castor, which offer the benefit of not competing for space with food crops and can be grown in difficult climates.

Due to the increased interest to abate fossil hydrocarbon feedstock to the petrochemical sector (plastic production), and to fuels production a higher demand is expected for the hydroprocessing of advanced renewable feedstocks, such as pyrolysis oils derived from solid renewable feedstocks.

Pyrolysis oils and the like from waste plastic are highly unsaturated containing olefins, diolefins, conjugated diolefins, aromatics, vinyl-aromatics as well as saturated hydrocarbons. These oils furthermore contain heteroatoms like nitrogen, oxygen, sulfur and halogens. Nitrogen may be present in biological material or selected polymers and organic halides may be present from biological sources or from plastic, such as chloride from PVC, bromide from flame retardants and fluoride from polyfluoroalkyls. The exact nature of plastic derived oils depends greatly on the polymer composition of the feedstock to the liquefaction process. In order to fulfil the requirements as petrochemical feedstock (for steam crackers) the olefinic hydrocarbons must be saturated and the heteroatoms must be decreased significantly.

Pyrolysis oils and the like from biomass may have a very high oxygen content, which needs to be decreased before it efficiently can be used as liquid fuel, i.e. as hydrocarbon fuel boiling in the transportation fuel range. The heteroatoms (like nitrogen, oxygen, sulfur and halogens) are generally removed by hydroprocessing in a catalytic hydrotreatment (HDT) reactor using high pressure (3000-20000 kPa) and high temperature (320-400° C.). However, a liquid oil such as pyrolysis oil or a hydrothermal liquefaction oil (hereinafter also referred to as HTL oil) is very unstable and when heated it tends to polymerize, which leads to rapid catalyst deactivation and plugging of the catalyst bed of the HDT reactor, due to coking or gum formation. As a result, if mild stabilization is not practiced, the unstable, highly reactive molecules will polymerize and solidify leading to increased reactor down time.

As a result, methods of stabilising liquid oils such as pyrolysis oils or HTL oils at lower (<250° C.) temperatures have been developed. This stabilization at least partially converts organic nitrogen to ammonia and organic halides to hydrogen halides. However, in these cases, it has now been identified that salts, in particular ammonium salts, can form and be deposited in the reactor as the operation temperature is below the salt precipitation temperature. In reactors operated at standard high temperatures, ammonia and hydrogen halides may be formed in the reactor, but the reactor temperature is sufficiently high to keep these molecules in the gas phase, such that salts thereof are not deposited on the reactor bed. However, at the lower operating temperatures desired for stabilising liquid oils such as pyrolysis oils or HTL oils, the salts can precipitate in the reactor itself.

Having salt precipitation in the stabilization reactor is a significant issue particularly since the salt precipitate may be deposited on the catalyst bed including within the pores of any hydrotreatment catalyst. This subsequently leads to blocking of the catalyst bed and rapid deactivation of the catalyst.

It would thus be desirable to provide a process for stabilising a liquid oil stream at low temperatures that circumvents the problems associated with salt precipitation in the reactor.

### SUMMARY OF THE INVENTION

In one aspect the in-situ catalyst regeneration step comprises washing the fixed bed reactor with water.

In another aspect there is provided a process for hydrotreating a liquid oil stream comprising at least 1 ppm wt halides, 20 ppm wt halides, 50 ppm wt halides or 100 ppm wt halides in combination and at least 1 ppm wt N, 10 ppm wt N, 50 ppm wt N, 100 ppm wt N or 500 ppm wt N; wherein the liquid oil stream is a thermochemical decomposition oil stream; the process comprising:
(i) a hydrotreatment step comprising hydrotreating the liquid oil stream in a fixed bed reactor at a temperature of less than 250° C., wherein the fixed bed reactor comprises a hydrotreatment catalyst; and
(ii) an in-situ catalyst regeneration step, wherein the in-situ catalyst regeneration step comprising flushing the hydrotreatment catalyst under regeneration conditions with a fluid, where said fluid and conditions are chosen, such that the solubility of ammonium salts in the fluid is sufficient for transferring deposited ammonium salts to the fluid.

This has the effect of one or more ammonium salts deposited on the hydrotreatment catalyst and process equipment are released from the hydrotreatment catalyst and transferred to the fluid. The term solubility shall in this regard be understood as the ability of the fluid to contain such salts, either in liquid solution or as gaseous mixture.

### DETAILED DESCRIPTION OF THE INVENTION

As discussed herein, in one aspect there is provided a process for hydrotreating a liquid oil stream; wherein the liquid oil stream is a thermochemical decomposition oil stream; the process comprising:
(i) a hydrotreatment step comprising hydrotreating the liquid oil stream in a fixed bed reactor at a temperature of less than 250° C., wherein the fixed bed reactor comprises a hydrotreatment catalyst; and
(ii) an in-situ catalyst regeneration step such that one or more ammonium salts deposited on the hydrotreatment catalyst are removed from the hydrotreatment catalyst, wherein the in-situ catalyst regeneration step comprises heating the hydrotreatment catalyst with a flushing gas, a mixture of a flushing gas and oil, such as product oil or an aqueous solution, such as water.

Specifically step (ii) may be an in-situ catalyst regeneration step, wherein the in-situ catalyst regeneration step comprising flushing the hydrotreatment catalyst under regeneration conditions with a fluid, where said fluid and conditions are chosen, such that the solubility of ammonium salts in the fluid is sufficient for transferring deposited ammonium salts to the fluid. While such a step is denoted a catalyst regeneration step, it shall be understood broadly as a regeneration step for the process equipment, and e.g. in the case of cold spots in the equipment, may be carried out even with no or little deactivation of catalyst. This regeneration shall be construed as being included in the term catalyst regeneration step, and the terminology catalytic material regeneration shall be applied for a step where only the catalytic material is regenerated.

By the present invention, the thermochemical decomposition oil stream, e.g. pyrolysis oil or hydrothermal liquefaction oil is stabilized at low temperatures by the conversion of at least the most reactive compounds in the thermochemical decomposition oil stream, such as furfural, furans, aldehydes, ketones and acids, into alcohols, for instance by efficiently converting carbonyl functional groups into alcohol functional groups. In addition, conjugated diolefins may be converted to mono-olefins, styrene may be converted to ethyl benzene and conjugated diolefins and styrene homologues may be hydrogenated. The present invention provides a process for this mild stabilisation whilst circumventing issues associated with the precipitation of ammonium-based salts within the reactor. As a result, clogging and subsequent deactivation of the hydrotreatment catalyst can be mitigated against.

Ammonium based salts may precipitate especially during the hydrotreatment of oil comprising at least 1 ppm wt N, 10 ppm wt N, 50 ppm wt N, 100 ppm wt N or 500 ppm wt N; in combination with at least 1 ppm wt N, 20 ppm wt halides, 50 ppm wt halides or 100 ppm wt halides, but also sulfur salts may precipitate, so a combination with presence of at least 20 ppm wt S, 50 ppm wt S or 100 ppm wt S may be especially relevant for this process, as ammonium bisulfite precipitate at higher temperatures than ammonium halides. In practice the content of N will be below 5-10 wt % and ha and S will be below 1 wt %. With less than 1 ppm wt N and 1 ppm wt of halides, precipitation may still occur, and the invention is therefore also valid and applicable for such feeds, but the amount of precipitation may be sufficiently low for operation for up to a year without a need for regeneration. These limits are given for halides, since at least F, CI and Br are found in thermochemical decomposition oil from thermochemical decomposition of plastic, such as CI from PVC, Br from flame retardants and F from PFAS compounds. The risk of precipitation will be lower if the release of inorganic halides from organic halide compounds by hydrotreatment is only partial.

### Liquid Oil Stream

As used herein, the term “liquid oil stream” refers to a thermochemical decomposition oil stream and relates to a feedstock comprising compounds which at above elevated temperatures (>80° C.) but below the temperatures resulting in substantially complete hydrotreatment may react to form larger molecules, potentially resulting in full or partial blockage of reactors, tubes, heaters, heat exchangers and catalysts. Examples of such mixtures may be feedstock rich in conjugated diolefins or styrene and its homologues from thermochemical decomposition of plastic waste, waste tyres, municipal solid waste, refuse derived fuel and solid recovered fuel, feedstock rich in carbonyls and sugars from thermochemical decomposition of lignocellulosic biomass and feedstock rich in nitrogen from thermochemical decomposition of nitrogen rich biomass, such as manure and sewage sludge, and similar composition from other sources. The reactive compounds may either react within the same functional group (for example, diolefin with diolefin) or across functional groups (for example, aldehyde with phenol).

As discussed herein, the process of the invention relates to hydrotreatment of a liquid oil stream i.e., a thermochemical decomposition oil stream, such as a fossil oil stream, a renewable crude oil stream or a biocrude oil stream. In one aspect, the liquid oil stream contains at least 20 wt % oxygen (O), such as at least 30 wt % O, or at least 45 wt % O. In one aspect, the liquid oil stream contains from 1 to 50 wt % O, such as from 5 to 50 wt % O, such as from 10 to 50 wt % O, such as from 15 to 50 wt % O, such as from 20 to 50 wt % O, such as from 25 to 50 wt % O, such as from 30 to 50 wt % O, such as from 35 to 50 wt % O, such as from 40 to 50 wt % O, such as from 45 to 50 wt % O. The oxygen is suitably determined by standard elemental analysis. This oxygen content is representative of particularly reactive liquid oil feeds, such as pyrolysis oils or hydrothermal liquefaction (HTL) oils, as the content of oxygen may serve as a proxy for how reactive the liquid oil is. Thus, a highly reactive liquid oil stream may contain as much as 45 wt % oxygen or even higher.

In one aspect, the liquid oil stream contains at least 500 ppm wt O, such as 0.1 wt. % O, such as at least 0.5 wt. % O, such as at least 1 wt. %, such as at least 1.5 wt. % O, such as at least 2 wt. % O, such as at least 2.5 wt. % O, such as at least 3 wt. % O, such as at least 3.5 wt. % O, such as at least 4.5 wt. % O, such as at least 5 wt. % O, such as at least 10 wt. % O, such as at least 15 wt. % O, which is representative of feedstock originating from the pyrolysis of material rich in plastic waste. In one aspect, the liquid oil stream contains from 0.1 to 15 wt. % O, such as from 0.5 to 15 wt. % O, such as from 1 to 15 wt. % O, such as from 2 to 15 wt. % O, such as from 3 to 15 wt. % O, such as from 4 to 15 wt. % O, such as from 5 to 15 wt. % O, such as from 6 to 15 wt. % O, such as from 7 to 15 wt. % O, such as from 8 to 15 wt. % O, such as from 9 to 15 wt. % O, such as from 10 to 15 wt. % O, such as from 11 to 15 wt. % O, such as from 12 to 15 wt. % O, such as from 13 to 15 wt. % O, such as from 14 to 15 wt. % O.

In one aspect, the thermochemical decomposition oil stream is a pyrolysis oil stream or a hydrothermal liquefaction oil (HTL oil) stream. In one aspect, the thermochemical decomposition oil stream is a pyrolysis oil stream. In one aspect, the thermochemical decomposition oil stream is a hydrothermal liquefaction oil (HTL oil) stream.

In one aspect the thermochemical decomposition oil stream is a pyrolysis oil stream which comprises at least 0.5 mol/kg of one or more of: aldehyde compounds, ketones, alcohols, furfural, as determined by ASTM E3146-20 or alternatively at least 0.5 gl/100 g conjugated diolefins as determined according to ASTM UOP-326.

In one aspect, the process of the invention further comprises a prior step of thermal decomposition of a solid renewable feedstock, for producing said thermochemical decomposition oil stream.

As used herein, the term “thermal decomposition” shall be used broadly for any decomposition process, in which a material is partially decomposed at elevated temperature (typically 250° C. to 800° C. or even 1000° C.), in the presence of a substoichiometric amount of oxygen (including no oxygen). The product will typically be a combined liquid and gaseous stream, as well as an amount of solid char. The term shall be construed to include processes known as pyrolysis and hydrothermal liquefaction, both in the presence and absence of a catalyst.

Accordingly, in a particular embodiment, the thermal decomposition is pyrolysis, such as fast pyrolysis, as defined below, thereby producing a pyrolysis oil stream.

It would be understood that thermal decomposition may be conducted in a thermal decomposition section, the pyrolysis may be conducted in a pyrolysis section, and hydrothermal liquefaction may be conducted in a hydrothermal liquefaction section.

As used herein, the term “section” means a physical section comprising a unit or combination of units for conducting one or more steps and/or sub-steps. For the purposes of the present invention, the pyrolysis section generates two main streams, namely a pyrolysis off-gas stream and a pyrolysis oil stream. The pyrolysis section may be in the form of a fluidized bed, transported bed, or circulating fluid bed, as is well known in the art. For instance, the pyrolysis section may comprise a pyrolyser unit (pyrolysis reactor), cyclone(s) to remove particulate solids such as char, and a cooling unit for thereby producing said pyrolysis off-gas stream and said pyrolysis oil stream, i.e. condensed pyrolysis oil. The pyrolysis off-gas stream comprises light hydrocarbons e.g. C1-C4 hydrocarbons, CO and CO₂. The pyrolysis oil stream is also referred to as a fossil oil stream, a renewable crude oil stream or a biocrude oil stream and is a liquid substance rich in blends of molecules including saturated and unsaturated hydrocarbons, cyclic and aliphatic, as well as hydrocarbons that contain heteroatoms like nitrogen, oxygen, halogens and sulfur. Unsaturated hydrocarbons possibly includes conjugated diolefins, styrene and styrene homologues. Hydrocarbons that contain heteroatoms includes nitriles, amines, amides, thioles, sulfides, thiophenes, aldehydes, ketones and/or other compounds such as furfural having a carbonyl group, resulting from the depolymerization of the feedstock treated in pyrolysis.

For the purposes of the present invention, the pyrolysis is preferably fast pyrolysis or slow pyrolysis. Fast pyrolysis means the thermal decomposition of a solid renewable feedstock in the absence of oxygen, at temperatures in the range 350-650° C., e.g., about 500° C., and reaction times of 10 seconds or less, such as 5 seconds or less, such as 2 seconds or less. Fast pyrolysis may be conducted by autothermal operation e.g. in a fluidized bed reactor. The latter is also referred to as autothermal pyrolysis and is characterized by employing air, optionally with an inert gas or recycle gas, as the fluidizing gas, or by using a mixture of air and inert gas or recycle gas. Thereby, the partial oxidation of pyrolysis compounds being produced in the pyrolysis reactor (autothermal reactor) provides the energy for pyrolysis while at the same time improving heat transfer. For details about autothermal pyrolysis, reference is given to e.g “Heterodoxy in Fast Pyrolysis of Biomass” by Robert Brown: https://dx.doi.org/10.1021/acs.energyfuels.0c03512.

“Intermediate” or “slow” pyrolysis are also suitable for feedstocks originating from waste plastics, and has lower cost and complexity than fast pyrolysis, and is currently the most widespread form of pyrolysis used for plastic waste and gives good oil yields. Biological feedstocks comprising alkaline metals have an increased risk of agglomeration and defluidization for slow pyrolysis.

In another embodiment, therefore, the pyrolysis step is intermediate pyrolysis, in which the vapor residence time is in the range of 10 seconds-5 minutes, such as 11 seconds-3 minutes. As for fast pyrolysis, the temperature is also in the range 350-650° C. e.g. about 500° C. Often this pyrolysis is conducted in pyrolysis reactors handling different types of waste, where the vapor is burned after the pyrolysis reactor. Typical reactors are: Herreshoff furnace, rotary drums, amaron, CHOREN paddle pyrolysis kiln, auger reactor, and vacuum pyrolysis reactor.

In another embodiment, the pyrolysis step is slow pyrolysis, in which the solid residence time is in the range of 5 minutes-2 hours, such as 10 min-1 hour. The temperature is suitably about 300° C. This pyrolysis gives a high char yield and the char can be used as a fertilizer or as char coal; the pyrolysis still produces some gas and renewable crude and if the carbon is used a fertilizer the final bio-oil can have a GHG above 100%, thus being carbon negative. Typical reactors are auger reactor (yet with a different residence time than for intermediate pyrolysis), fixed bed reactor, kiln, lambiotte SIFIC/CISR retort, Lurgi process, wagon reactor, and carbo twin resort.

It would therefore be understood, that for the purpose of the present invention, the use of autothermal pyrolysis. i.e. autothermal operation, is a particular embodiment for conducting fast pyrolysis.

There are several types of fast pyrolysis where a catalyst is used. Sometimes an acid catalyst, such as zeolite or silica-alumina catalysts, is used in the pyrolysis reactor to upgrade the pyrolysis vapors, this technology is called catalytic fast pyrolysis and can both be operated in an in-situ mode (the catalyst is located in the pyrolysis reactor) and an ex-situ mode (the catalyst is placed in a separate reactor). The use of a catalyst conveys the advantage of lowering the activation energy for reactions thereby significantly reducing the required temperature for conducting the pyrolysis. In addition, increased selectivity towards desired pyrolysis oil compounds may be achieved. In some cases, hydrogen is added to the catalytic pyrolysis, which is called reactive catalytic fast pyrolysis. If the catalytic pyrolysis is conducted at a high hydrogen pressure (~>0.5 MPag) it is often called catalytic hydropyrolysis. In one aspect, the pyrolysis stage is fast pyrolysis, which is conducted without the presence of a catalyst and hydrogen, i.e. the fast pyrolysis stage is not catalytic fast pyrolysis, hydropyrolysis or catalytic hydropyrolysis. This enables a much simpler and inexpensive process.

In one aspect, said pyrolysis off-gas stream comprises CO, CO₂ and light hydrocarbons such as C1-C4, and optionally also H₂S, HCl, HBr, HF, HCN and NH₃.

In one aspect, the thermal decomposition is hydrothermal liquefaction. Hydrothermal liquefaction means the thermochemical conversion of biomass into liquid fuels by processing in a hot, pressurized water environment for sufficient time to break down the solid polymeric structure to mainly liquid components. Typical hydrothermal processing conditions are temperatures in the range from 200° C. or 250° C. to 375° C. or 425° C. and operating pressures in the range of 4 MPag to 22 MPag or 25 MPag. This technology offers the advantage of operation at a lower temperature, higher energy efficiency and lower tar yield compared to pyrolysis, e.g. fast pyrolysis. For details on hydrothermal liquefaction of biomass, reference is given to e.g. Golakota et al., “A review of hydrothermal liquefaction of biomass”, Renewable and Sustainable Energy Reviews, vol. 81, Part 1, January 2018, p. 1378-1392.

In one aspect, the thermal decomposition further comprises passing said solid renewable feedstock through a solid renewable feedstock preparation section comprising for instance drying for removing water and/or comminution for reduction of particle size. Any water/moisture in the solid renewable feedstock, which vaporizes in for instance the pyrolysis section, condenses in the pyrolysis oil stream and is thereby carried out in the process, which may be undesirable. Furthermore, the heat used for the vaporization of water withdraws heat which otherwise is necessary for the pyrolysis. By removing water and providing a smaller particle size in the solid renewable feedstock, the thermal efficiency of the pyrolysis section is increased.

In an embodiment, the solid renewable feedstock is a lignocellulosic biomass including: wood products, forestry waste, and agricultural residue. In another embodiment, the solid renewable feedstock is municipal waste, in particular the organic portion thereof. For the purposes of the present application, the term “municipal waste” is interchangeable with the term “municipal solid waste” and means a feedstock containing materials of items discarded by the public, such as mixed municipal waste given the waste code 200301 in the European Waste Catalogue.

In one aspect, the lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

In one aspect, the solid renewable feedstock is waste plastic or municipal waste rich in waste plastic.

Any combinations of the above is also envisaged.

As used herein, the term “lignocellulosic biomass” means a biomass containing, cellulose, hemicellulose and optionally lignin. The lignin or a significant portion thereof may have been removed, for instance by a prior bleaching step.

The terms a “feedstock of plastic or polymeric origin” or “waste plastic or polymer” may be understood as including a mixed or sorted waste comprising at least 50 wt %, 80 wt % or 90 wt % plastic and other synthetic polymers.

The units “kPag” and MPag, shall in compliance with the practice of the field be used to denote kPa and MPa, gauge, i.e. the pressure relative to the surrounding pressure.

### Hydrotreatment Step

As discussed herein, the process of the invention comprises an initial hydrotreatment step comprising hydrotreating the liquid oil stream in a fixed bed reactor at a temperature of less than 250° C., wherein the fixed bed reactor comprises a hydrotreatment catalyst.

In one aspect the liquid oil stream is hydrotreated in the fixed bed reactor at a temperature of less than 400° C., such as less than 390° C., such as less than 380° C., such as less than 370° C., such as less than 360° C., such as less than 350° C., such as less than 340° C., such as less than 330° C., such as less than 320° C., such as less than 310° C., such as less than 300° C., such as less than 290° C., such as less than 280° C., such as less than 270° C., such as less than 260° C., such as less than 250° C., such as less than 240° C., such as less than 230° C., such as less than 220° C., such as less than 210° C., such as less than 200° C., such as less than 190° C., such as less than 180° C., such as less than 170° C., such as less than 160° C., such as less than 150° C., such as less than 140° C., such as less than 130° C., such as less than 120° C., such as less than 110° C., such as less than 100° C., such as less than 90° C., such as less than 80° C., such as less than 70° C. In one aspect the liquid oil stream is hydrotreated in the fixed bed reactor at a temperature of from 70 to 400° C., such as from 70 to 390° C., such as from 70 to 380° C., such as from 70 to 370° C., such as from 70 to 360° C., such as from 70 to 350° C., such as from 70 to 340° C., such as from 70 to 330° C., such as from 70 to 320° C., such as from 70 to 310° C., such as from 70 to 300° C., such as from 70 to 290° C., such as from 70 to 280° C., such as from 70 to 270° C., such as from 70 to 260° C., such as from 70 to 250° C., such as from 70 to 240° C., such as from 70 to 230° C., such as from 70 to 220° C., such as from 70 to 210° C., such as from 70 to 200° C., such as from 70 to 190° C., such as from 70 to 180° C., such as from 70 to 170° C., such as from 70 to 160° C., such as from 70 to 150° C., such as from 70 to 140° C., such as from 70 to 130° C., such as from 70 to 120° C., such as from 70 to 110° C., such as from 70 to 100° C., such as from 70 to 90° C., such as from 70 to 80° C. In one aspect, the liquid oil stream is hydrotreated in a fixed bed reactor at a temperature in the range 80-300° C., such as in the range 150-250° C., such as in the range 150-200° C.

In one aspect, the temperature is in the range 100-225° C., e.g. 150-200° C.; the pressure is from 1 MPag, 4 MPag, 10 MPag or 12.5 MPag to 16 MPag or 17.5 MPag e.g. 15 MPag; and LHSV is 0.8-1.0 h⁻¹ e.g. 0.9 h⁻¹. At these particular conditions, compounds such as cyclopentanone or furfural present in e.g. pyrolysis oil are substantially converted to the respective alcohols. For instance, at 150-200° C., about 15 MPag, and LHSV of about 0.9 h⁻¹, optionally where the hydrogen to liquid oil ratio is 1000-1300 NL/L e.g. 1100-1200 NL/L, the conversion of furfural, an organic compound normally derived from the renewable source lignocellulosic biomass, is up to 100%.

In one aspect, the temperature is in the range 80-200° C., the pressure is from 1.0-17.5 MPag, LHSV is from 1 h⁻¹ to 10 h⁻¹, the H2-to-oil ratio is from 5 NL/L to 1000 NL/L. These hydrotreatment conditions are ideal for the hydrogenation of conjugated diolefins, styrene and styrene homologues.

In one aspect, the hydrotreatment catalyst converts at least one of conjugated diolefins to the corresponding monoolefin or paraffin, styrene to ethylbenzene, furfural, furans, aldehydes, ketones and acids, into alcohols, and/or carbonyls into alcohols. The alcohols can further be converted to saturated organic compounds during the stabilization, and/or in a subsequent hydroprocessing stage such as HDO.

In one aspect, the hydrotreatment catalyst is selected from the group comprising Mo, Ni, Co, W, Pt, Pd, Cu, Fe, Zn and Ru based catalysts and combinations thereof. In one aspect, the catalyst is in sulfided or reduced form.

In one aspect, the catalyst is Ni-based, Mo-based, CoMo-based, NiMo-based, W-based, NiW-based or Ru-based. In one aspect, the catalyst is in sulfided, partially sulfided (i.e., surface-passivated with sulfur) or reduced form.

In one aspect, the Ni-based catalyst comprises Ni in an amount of at least 90 wt % based on the Group 1-12 materials in the catalyst, such as at least 95 wt. % such as at least 99 wt. % such as 100 wt. %. In one aspect, the Mo-based catalyst comprises Mo in an amount of at least 90 wt % based on the Group 1-12 materials in the catalyst, such as at least 95 wt. % such as at least 99 wt. % such as 100 wt. %. In one aspect, the W-based catalyst comprises W in an amount of at least 90 wt % based on the Group 1-12 materials in the catalyst, such as at least 95 wt. % such as at least 99 wt. % such as 100 wt. %. In one aspect, the Ru-based catalyst comprises Ru in an amount of at least 90 wt % based on the Group 1-12 materials in the catalyst, such as at least 95 wt. % such as at least 99 wt. % such as 100 wt. %.

In one aspect, the Ni-based catalyst comprises from 2-30 wt % Ni sulfided or reduced. In one aspect, the Mo-based catalyst comprises from 2-30 wt % Mo preferably sulfided. In one aspect, the CoMo-based catalyst comprises from 1-10 wt % Co and from 2-30 wt % Mo preferably sulfided. In one aspect, the NiMo-based catalyst comprises from 1-10 wt % Ni and from 2-30 wt % Mo preferably sulfided. In one aspect, the W-based catalyst comprises from 2-30 wt % W preferably sulfided. In one aspect, the NiW-based catalyst comprises from 1-10 wt % Ni and from 2-30 wt % W preferably sulfided. In one aspect, the Ru-based catalyst comprises from 0.1-10 wt % Ru preferably reduced.

In one aspect, the hydrotreatment catalyst comprises Mo. In one aspect, the hydrotreatment catalyst comprises Co. In one aspect, the hydrotreatment catalyst comprises Ni. In one aspect, the hydrotreatment catalyst comprises W. In one aspect, the hydrotreatment catalyst comprises Pt. In one aspect, the hydrotreatment catalyst comprises Pd. In one aspect, the hydrotreatment catalyst comprises Cu. In one aspect, the hydrotreatment catalyst comprises Fe. In one aspect, the hydrotreatment catalyst comprises Zn. In one aspect, the hydrotreatment catalyst comprises Ru. In one aspect, the hydrotreatment catalyst is a Ni—Mo based catalyst.

In one aspect the hydrotreatment catalyst is a supported catalyst. In one aspect, the support is selected from alumina, silica, titania, magnesia and combinations thereof, i.e. a refractory support. The combinations may be as physical mixtures or as oxide systems, such as silica-alumina, alumina-magnesia spinel and other spinel-group oxide systems. In another particular embodiment, the support is a molecular sieve having topology MFI, BEA or FAU. As used herein, the term “topology MFI, BEA or FAU”, means a structure as assigned and maintained by the International Zeolite Association Structure Commission in the Atlas of Zeolite Framework Types, which is at http://www.iza-structure.org/databases/or for instance also as defined in “Atlas of Zeolite Framework Types”, by Ch. Baerlocher, L. B. McCusker and D. H. Olson, Sixth Revised Edition 2007.

In one aspect, the catalyst is sulphided. In one aspect, the hydrotreatment catalyst is a Ni—Mo based catalyst in sulfided form, i.e. NiMoS. In one aspect, the hydrotreatment catalyst is a Co—Mo based catalyst in sulfided form, i.e. CoMoS. The catalyst may be pre-sulfided by exposure to a sulfur containing stream or it may be sulfided in-situ i.e. during operation, for instance by sulfur present in the pyrolysis oil. In one aspect, the catalyst is reduced from oxide form to metallic form. In one aspect, the catalyst is pre-reduced or reduced by exposure to a hydrogen containing stream in-situ.

By the present invention, it has been found that an alcohol in the pyrolysis oil is first dehydrated to the respective unsaturated organic compound e.g. alkene and then hydrogenated to the respective saturated organic compound, e.g. alkane. For instance, 1-octanol present in the pyrolysis oil is first dehydrated to octene and then hydrogenated to octane. On the other hand, a ketone such as cyclopentanone (a cyclic ketone) is first hydrogenated to the respective alcohol, namely cyclopentanol and then dehydrated to cyclopentene, prior to being hydrogenated to cyclopentane. The dehydration is inhibited by pyridine (C₅H₅N, i.e. a compound having an organic nitrogen) present in the pyrolysis oil, thus indicating that pyridine is adsorbed on the acid sites. However, the hydrogenation is not inhibited by pyridine, thus showing that the catalyst according to the conditions of the present invention is able to convert aldehydes and ketones or other compounds having carbonyl groups in the pyrolysis oil, which normally contains organic sulfur and nitrogen, to alcohols. In other words, the desired reaction in which compounds having carbonyl groups such as aldehydes and ketones, are converted by hydrogenation to their corresponding alcohols is enabled. The alcohols may be dehydrated to the corresponding alkanes, either as part of the reactions taking place in the stabilization, or in a subsequent hydrodeoxygenation. In addition, saturation of conjugated diolefins and styrene homologues in the liquid oil as well as a reduction in the amount of heteroatoms is enabled

### In-Situ Catalyst Regeneration Step

As discussed herein, methods of stabilising liquid oils such as pyrolysis oils or HTL oils at low temperatures have been developed. However, in these cases, it has been identified that salts can form and deposit in the reactor as the operation temperature is below the salt precipitation temperature. Having salt precipitation in the stabilization reactor is a significant issue particularly since the salt precipitate may be deposited on the catalyst bed including within the pores of the catalyst. This subsequently leads to blocking of the catalyst bed and rapid deactivation of the hydrotreatment catalyst.

As a result, as discussed herein the process of the invention comprises an in-situ catalyst regeneration step such that one or more ammonium salts deposited on the hydrotreatment catalyst are removed from the hydrotreatment catalyst.

In one aspect, the one or more ammonium salts are selected from ammonium halides, ammonium hydrosulfide and mixtures thereof. In one aspect, the one or more ammonium salts are ammonium halides and mixtures thereof. In one aspect, the one or more ammonium salts are ammonium hydrosulfides and mixtures thereof. In one aspect, the one or more ammonium salts are at least ammonium chloride.

In one aspect, the in-situ catalyst regeneration step comprises heating the hydrotreatment catalyst with a fluid such as a flushing gas, or mixtures of a flushing gas and oil, such as a product oil. In one aspect, the in-situ catalyst regeneration step comprises heating the hydrotreatment catalyst with a flushing gas. In one aspect, the in-situ catalyst regeneration step comprises heating the hydrotreatment catalyst with a mixture of a flushing gas and oil, such as product oil. The heating is commonly carried out by contact with a heated fluid.

Heating the hydrotreatment catalyst leads to sublimation of any ammonium salts deposited thereon, such that the solid salts are decomposed into NH₃ and hydrogen halides in the gas phase and can be removed from the reactor and the hydrotreatment catalyst regenerated.

In one aspect, the flushing gas remains in the gas phase during all operating conditions and does not react with any catalyst or corrode construction materials. In one aspect, the flushing gas is selected from a hydrogen rich gas, a nitrogen rich gas, a helium rich gas, an argon rich gas, a methane rich gas and combinations thereof.

In one aspect, the flushing gas is a hydrogen rich gas. In one aspect, the hydrogen rich gas contains hydrogen in an amount of 60 vol. %. In one aspect, the hydrogen rich gas contains hydrogen in an amount of 65 vol. %. In one aspect, the hydrogen rich gas contains hydrogen in an amount of 70 vol. %. In one aspect, the hydrogen rich gas contains hydrogen in an amount of 75 vol. %. In one aspect, the hydrogen rich gas contains hydrogen in an amount of 80 vol. %. In one aspect, the hydrogen rich gas contains hydrogen in an amount of 85 vol. %. In one aspect, the hydrogen rich gas contains hydrogen in an amount of 95 vol. %. In one aspect, the hydrogen rich gas contains hydrogen in an amount of 99 vol. %.

In one aspect, the flushing gas is a nitrogen rich gas. In one aspect, the nitrogen rich gas contains nitrogen in an amount of 60 vol. %. In one aspect, the nitrogen rich gas contains nitrogen in an amount of 65 vol. %. In one aspect, the nitrogen rich gas contains nitrogen in an amount of 70 vol. %. In one aspect, the nitrogen rich gas contains nitrogen in an amount of 75 vol. %. In one aspect, the nitrogen rich gas contains nitrogen in an amount of 80 vol. %. In one aspect, the nitrogen rich gas contains nitrogen in an amount of 85 vol. %. In one aspect, the nitrogen rich gas contains nitrogen in an amount of 95 vol. %. In one aspect, the nitrogen rich gas contains nitrogen in an amount of 99 vol. %.

In one aspect, the flushing gas contains sulphur. In one aspect, the flushing gas is a hydrogen rich gas containing hydrogen sulfide. In one aspect, the hydrogen rich gas contains NH₃. In one aspect the hydrogen rich gas contains hydrogen halides.

In one aspect, during the regeneration step the hydrotreatment catalyst is heated at a temperature of from 100 to 400° C. In one aspect, the hydrotreatment catalyst is heated at a temperature of from 150 to 400° C. In one aspect, the hydrotreatment catalyst is heated at a temperature of from 200 to 400° C. In one aspect, the hydrotreatment catalyst is heated at a temperature of from 250 to 400° C. In one aspect, the hydrotreatment catalyst is heated at a temperature of from 300 to 400° C. In one aspect, the hydrotreatment catalyst is heated at a temperature of from 350 to 400° C.

In one aspect, during the regeneration step the hydrotreatment catalyst is heated at a temperature of from 100 to 350° C. In one aspect, the hydrotreatment catalyst is heated at a temperature of from 100 to 300° C. In one aspect, the hydrotreatment catalyst is heated at a temperature of from 100 to 250° C. In one aspect, the hydrotreatment catalyst is heated at a temperature of from 100 to 200° C. In one aspect, the hydrotreatment catalyst is heated at a temperature of from 100 to 150° C.

In one aspect, during the regeneration step the hydrotreatment catalyst is heated at a temperature of from 150 to 350° C. In one aspect, the hydrotreatment catalyst is heated at a temperature of from 200 to 350° C. In one aspect, the hydrotreatment catalyst is heated at a temperature of from 150 to 300° C. In one aspect, the hydrotreatment catalyst is heated at a temperature of from 250 to 300° C. In one aspect, the hydrotreatment catalyst is heated at a temperature of from 200 to 250° C.

In one aspect, the catalyst regeneration step is performed at a pressure substantially corresponding to atmospheric pressure such as deviating by less than 15 kPa from atmospheric pressure e.g. from 15 kPa below atmospheric pressure to 15 kPa above atmospheric pressure. In one aspect, the catalyst regeneration step is performed at a pressure deviating by less than 13 kPa from atmospheric pressure. In one aspect, the catalyst regeneration step is performed at a pressure deviating by less than 11 kPa from atmospheric pressure. In one aspect, the catalyst regeneration step is performed at a pressure deviating by less than 9 kPa from atmospheric pressure. In one aspect, the catalyst regeneration step is performed at a pressure deviating by less than 7 kPa from atmospheric pressure. In one aspect, the catalyst regeneration step is performed at a pressure deviating by less than 5 kPa from atmospheric pressure. In one aspect, the catalyst regeneration step is performed at a pressure deviating by less than 3 kPa from atmospheric pressure.

In one aspect, the catalyst regeneration step is performed at a pressure of 3000 to 15000 kPa. In one aspect, the catalyst regeneration step is performed at a pressure of 5000 to 15000 kPa. In one aspect, the catalyst regeneration step is performed at a pressure of 7000 to 15000 kPa. In one aspect, the catalyst regeneration step is performed at a pressure of 9000 to 15000 kPa. In one aspect, the catalyst regeneration step is performed at a pressure of 11000 to 15000 kPa. In one aspect, the catalyst regeneration step is performed at a pressure of 13000 to 15000 kPa.

In one aspect, the catalyst regeneration step is performed at a pressure of 3000 to 13000 kPa. In one aspect, the catalyst regeneration step is performed at a pressure of 3000 to 11000 kPa. In one aspect, the catalyst regeneration step is performed at a pressure of 3000 to 9000 kPa. In one aspect, the catalyst regeneration step is performed at a pressure of 3000 to 7000 kPa.

In one aspect, the hydrotreatment catalyst is heated as above for a period of at least 0.5 hours. In one aspect, the hydrotreatment catalyst is heated as above for a period of at least 1 hours. In one aspect, the hydrotreatment catalyst is heated as above for a period of at least 2 hours. In one aspect, the hydrotreatment catalyst is heated as above for a period of at least 3 hours. In one aspect, the hydrotreatment catalyst is heated as above for a period of at least 4 hours. In one aspect, the hydrotreatment catalyst is heated as above for a period of at least 5 hours. In one aspect, the hydrotreatment catalyst is heated as above for a period of at least 10 hours. In one aspect, the hydrotreatment catalyst is heated as above for a period of at least 15 hours. In one aspect, the hydrotreatment catalyst is heated as above for a period of at least 20 hours. In one aspect, the hydrotreatment catalyst is heated as above for a period of at least 25 hours. In one aspect, the hydrotreatment catalyst is heated as above for a period of at least 30 hours.

In one aspect, the hydrotreatment catalyst is heated as above for a period of from 0.5 to 300 hours, such as from 1 to 300 hours, such as from 2 to 300 hours, such as from 3 to 300 hours, such as from 4 to 300 hours, such as from 5 to 300 hours, such as from 6 to 300 hours, such as from 7 to 300 hours, such as from 8 to 300 hours, such as from 9 to 300 hours, such as from 10 to 300 hours, such as from 20 to 300 hours, such as from 30 to 300 hours, such as from 40 to 300 hours, such as from 50 to 300 hours, such as from 60 to 300 hours, such as from 70 to 300 hours, such as from 80 to 300 hours, such as from 90 to 300 hours, such as from 100 to 300 hours, such as from 150 to 300 hours, such as from 200 to 300 hours, such as from 250 to 300 hours.

In one aspect, the in-situ catalyst regeneration step comprises washing the fixed bed reactor with water or an aqueous solution. Here the reactor is washed with water either by continual addition of wash water or by filling the reactor with water and subsequently emptying its contents after suitable residence time. The salt is released due to the solubility of the ionic compound in the aqueous solution.

### Process Operation

In one aspect, the process for hydrotreating a liquid oil stream of the present invention is a batch or non-continuous operation. In one aspect, the process for hydrotreating a liquid oil stream of the present invention is a continuous operation.

The term continuous operation, as is well known in the art, means that the incoming stream of liquid oil during a given production cycle is constant, as also is the stabilized liquid oil stream being withdrawn as the outcoming product. This contrasts a batch operation as is also well known in the art, in which the total amount of liquid oil and catalyst is introduced at the beginning of the process, and the outcoming product is withdrawn after a certain period of time.

In one aspect, the process for hydrotreating a liquid oil stream of the present invention is a continuous operation. In one aspect of the process discussed herein, during the catalyst regeneration step, the liquid oil stream is subjected to a hydrotreatment step in a second fixed bed reactor comprising hydrotreating the liquid oil stream in the second fixed bed reactor, wherein the second fixed bed reactor comprises a hydrotreatment catalyst. In this case, the process for hydrotreating a liquid oil stream can remain online in the second fixed bed reactor whilst the hydrotreatment catalyst of the first fixed bed reactor is regenerated in accordance with the above aspects.

In one aspect, the process of the present invention further comprises a second catalyst regeneration step such that one or more ammonium salts deposited on the hydrotreatment catalyst of the second fixed bed reactor are removed from the second fixed bed reactor hydrotreatment catalyst.

In one aspect, during the second catalyst regeneration step such that one or more ammonium salts deposited on the hydrotreatment catalyst of the second fixed bed reactor are removed from the second fixed bed reactor hydrotreatment catalyst, the liquid oil stream undergoes a hydrotreatment step comprising hydrotreating the liquid oil stream in the first fixed bed reactor at a temperature of less than 250° C., wherein the fixed bed reactor comprises a hydrotreatment catalyst.

In other words, hydrotreatment of the liquid oil stream may continue in the second fixed bed reactor whilst the hydrotreatment catalyst in the first fixed bed reactor is being regenerated and hydrotreatment of the liquid oil stream may continue in the first bed reactor whilst the hydrotreatment catalyst in the second fixed bed reactor is being regenerated.

The process of the present invention may comprise one or more further steps. These one or more further steps may be before, after, or intermediate to the steps recited herein.

For example, the effluents from the on-stream reactor and the regenerated reactor are mixed with other streams such as recycle oil streams and additional treat gas streams. The mixture is heated and treated in subsequent reactors. The stream is kept at high temperature through the process to ensure that the salts do not precipitate until the point where the effluent is washed with water. After washing the salts are moved to water phase and the sour water is sent to further treating.

In one aspect, the process involves further steps subsequent to the in-situ catalyst regeneration step that relate to treatment of the ammonium salts released from the hydrotreatment catalyst of the fixed bed reactor. For example, given that the in-situ catalyst regeneration step involves heating the hydrotreatment catalyst with a flushing gas, or mixtures of a flushing gas and hot product oil, the released gases comprising components of the ammonium salts (e.g., NH₃ and HCl) are sent to the effluent for washing at the wash water injection point.

In one aspect, the process relating to the treatment of the ammonium salts released from the hydrotreatment catalyst is dependent on the quantity of salt to be removed and the time period for removal and catalyst regeneration as well as the capacity of downstream equipment. With such information, the following parameters can be selected
The gas flow used in stripping operation. Higher gas flow implies higher stripping rate;
The temperature of stripping. The higher temperature the higher concentration of NH₃ and HCl in the gas is achievable; and
Operating pressures. Low pressure flow implies higher gas concentration of NH₃ and HCl and thus a higher stripping rate,

Assuming a constant operating pressure, the gas flow and temperature together will give a removal rate, when other factors are considered (efficiency due to mass transport limit, found by experiment, time fraction available for real stripping, time needed to recondition the reactor before and after stripping). By varying the gas flow and temperature, the suitable stripping operating condition can be identified that fulfils the catalyst bed stripping in the available time frame. In one aspect, the process has a three-phase separation step; splitting, gas and non-polar (hydrocarbon) and polar (aqueous) phases.

In one aspect the removal rate is controlled, such that the rate of released NH₃ and HCl is at least 50% and less than 150% or 200% of the amounts directed to the three-phase separation step during operation.

In one aspect, the catalyst regeneration step may be carried out at elevated pressure, such as 90% to 110% of the pressure of the hydrotreatment step with gases directed to the existing washing and separation equipment, so extra equipment is not required.

In one aspect, the catalyst regeneration step may be carried out at a pressure substantially corresponding to atmospheric pressure, with gases directed to dedicated catalyst regeneration washing and separation equipment, allowing for increased efficiency of removal, due to increased gas concentrations of NH₃ and HCl.

In one aspect, the process further comprises passing the stabilized oil stream through a hydrotreatment step in which heteroatoms are removed by hydrodemetalation (HDM), hydrodenitrification (HDN) and hydrodeoxygenation (HDO) step using catalysts with properties well known to the skilled person familiar with the impurities. Thereby, any organic nitrogen present in the stabilized pyrolysis oil stream is removed and a hydrotreated stream is produced, which can be further treated for producing hydrocarbon products suitable as petrochemical feedstock as well as hydrocarbon products boiling in the transportation fuel range, such as diesel, jet fuel and naphtha. The further treatment may include any of: hydrodewaxing, hydrocracking, or isomerization, as is well known in the art of fossil oil refining. Other types of hydrotreating are also envisaged, for instance hydrodearomatization (HDA). The material catalytically active in hydrodearomatization typically comprises an active metal (typically elemental noble metals such as platinum and/or palladium but possibly also sulfided base metals such as nickel, cobalt, tungsten and/or molybdenum) and a refractory support (such as amorphous silica-alumina, alumina, silica or titania, or combinations thereof).

### BRIEF DESCRIPTION OF THE DRAWINGS

Embodiments of the present invention are explained by way of examples and with reference to the accompanying drawings. The appended drawings illustrate only examples of embodiments of the present invention, and they are therefore not to be considered limiting of its scope, as the invention may admit to other alternative embodiments.

FIG. 1. Shows the reactor loading scheme employed in Example 1.

The invention will now be described with reference to the following non-limiting examples.

### EXAMPLES

The precipitation and sublimation of ammonia salts is described by the following reversible reaction (only the reaction for NH₄Cl is shown)

$${NH}_{3} ( g ) + HCl ( g ) ↔ {NH}_{4} Cl ( s )$$

The equilibrium is governed by a equilibrium constant Kp, defined as:

$$Kp = {P}_{{NH}_{3}} * {P}_{HCl}$$

where P_{NH}_{₃} is the partial pressure of NH₃ and P_{HCl} is the partial pressure of HCl. Kp is dependent on temperature. The relation between Kp and temperature can be found in API Recommended Practice 932-B, Third Edition, June 2019. Kp is large at high temperature. Kp defines a maximum product of P_{NH3} with P_{HCl} (P_{NH3}*P_{HCl}) in the gas phase at a given temperature. If the product of partial pressures of NH₃ and HCl is at maximum, we consider the gas saturated.

The removal rates of solid ammonium chloride from a catalyst via sublimation were tested using NH₄Cl-loaded 1/20″ trilobe alumina-based catalyst support extrudates (surface area: 240 m²/g, pore volume: 1.0 ml/g). The NH₄Cl-loaded extrudates were prepared with NH₄Cl loadings of ca. 9 wt % and a NH₄⁺:Cl molar ratio of 1.04-1.11 as measured by ion chromatography for NH₄⁺ (ASTM D6919) and Cl⁻ (ASTM D4327)

Baseline experiments accounting for effects of the loading and unloading procedure of the NH₄Cl-loaded extrudates in and out of the reactor, and any fast initial phenomena, were carried out under experimental conditions where ≤2.5% of the initial NH₄Cl could be removed on the basis of a NH₃- and HCl-saturated reactor exit gas from NH₄Cl(s) decomposition. The baseline experiments were carried out in H₂, and in H₂+ oil (hydrodesulphurized heavy naphtha, petroleum, white spirit type 1), at temperatures of 200° C. and 5 MPag for a duration of 3 hrs, 250° C. and 5 MPag for a duration of 2 hrs, and 300° C. and 16 MPag for a duration of 0.5 hrs. This resulted in NH₄⁺ mass balances (after/before) of 0.79 (within 4%) and Cl-mass balance of 0.95 (within 5%), and resulting NH₄⁺:Cl-molar ratios of 0.93 (within 6%). The fast initial step of some NH₃-loss from the NH₄Cl-loaded extrudates is assigned to a combination of desorption of superfluous NH₃ from the sample preparation (NH₄⁺:Cl-molar ratio of 1.04-1.11) and a fast partial NH₄Cl decomposition step to form chlorine chemical bonds with the alumina surfaces and a resulting NH₃ desorption at 200-300° C. The latter is well-known and is evident in Example 1 on the basis of the NH₄⁺:Cl molar ratios (<<1) after that test.

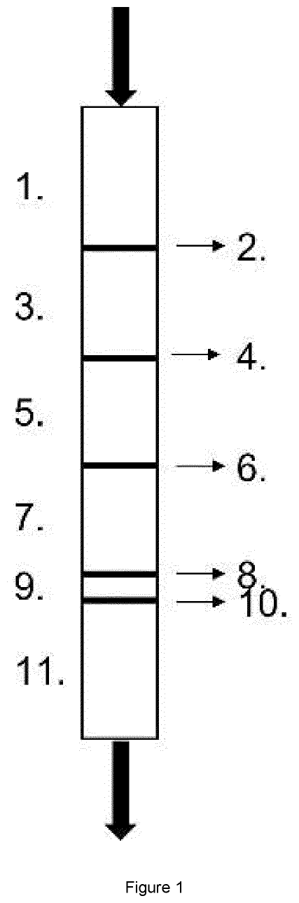

Experiments designed to remove significant amounts of NH₄Cl in a matter of a few days were also carried out, and the results are provided below. For this example, the reactor loading scheme is shown in FIG. 1 was employed, wherein the reference numerals for the reactor layers are as follows.
1. 3 mm acid-washed glass beads
2. Glass wool wad
3. NH₄Cl-loaded alumina-based support
4. Glass wool wad
5. NH₄Cl-loaded alumina-based support
6. Glass wool wad
7. NH₄Cl-loaded alumina-based support
8. Glass wool wad
9. Alumina-based support
10. Glass wool wad
11. Alkali-loaded alumina

### Example 1

Flow: H₂ (42.4 Nl/h), Pressure: 5 MPag, Temperature: 250° C., Duration: 30 hrs

| | | | | | Final |
|---|---|---|---|---|---|
| | Initial | Initial | Final | Final | NH4/Cl |
| Layer | NH4+/g | Cl−/g | NH4+/g | Cl−/g | molar ratio |
| 3 | 0.55 | 1.04 | 0.10 | 0.50 | 0.37 |
| 5 | 0.55 | 1.04 | 0.15 | 0.60 | 0.42 |
| 7 | 0.55 | 1.04 | 0.21 | 0.73 | 0.45 |
| 9 | 0.00 | 0.00 | 0.08 | 0.33 | 0.39 |
| 11 | 0.00 | 0.00 | 0.07 | 0.42 | 0.09 |
| 2 + 4 + 6 | 0.00 | 0.00 | 0.00 | 0.05 | 0.02 |
| 8 + 10 | 0.00 | 0.00 | 0.03 | 0.18 | 0.32 |
| Reactor exit | 0.00 | 0.00 | 0.07 | 0.15 | 0.96 |
| Mass balance | | | 0.44 | 0.95 | |

As can be seen, salt removal from the reactor bed was observed upon treatment with the hydrogen gas stream at the temperatures, pressures and times used.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, chemical engineering or related fields are intended to be within the scope of the following claims.

1. A process for hydrotreating a liquid oil stream; wherein the liquid oil stream is a thermochemical decomposition oil stream, comprising at least 1 ppm wt halides, in combination and at least 1 ppm wt N; the process comprising:
(i) a hydrotreatment step comprising hydrotreating the liquid oil stream in a fixed bed reactor at a temperature of less than 250° C., wherein the fixed bed reactor comprises a hydrotreatment catalyst; and
(ii) an in-situ catalyst regeneration step comprising flushing the hydrotreatment catalyst under regeneration conditions with a fluid, where said fluid and conditions are chosen; such that the solubility of ammonium salts in the fluid is sufficient for transferring deposited ammonium salts to the fluid.

2. A process according to claim 1 wherein the fluid is a liquid being able to dissolve the salt in ionic form.

3. A process according to claim 1 wherein the fluid is a gas having a temperature above that of step 1 being able to sublimate the salt to gaseous form.

4. A process according to claim 1 wherein the thermochemical decomposition oil stream is a pyrolysis oil stream, or wherein the thermochemical decomposition oil stream is a hydrothermal liquefaction oil stream.

5. A process according to claim 3, wherein the fluid is a hydrogen rich gas or a nitrogen rich gas optionally further comprising sulfur.

6. A process according to claim 1, wherein during the catalyst regeneration step the hydrotreatment catalyst is heated at a temperature of from 150 to 300° C.

7. A process according to claim 1 wherein the catalyst regeneration step is performed at a pressure of −15 kPag to 15000 kPag.

8. A process according to claim 5 wherein the gas contains hydrogen sulfide.

9. A process according to claim 1, wherein during the catalyst regeneration step, the liquid oil stream is subjected to a hydrotreatment step in a second fixed bed reactor comprising hydrotreating the liquid oil stream in the second fixed bed reactor, wherein the second fixed bed reactor comprises a hydrotreatment catalyst.

10. A process according to claim 9 further comprising
(iii) a second catalyst regeneration step such that one or more ammonium salts deposited on the hydrotreatment catalyst of the second fixed bed reactor are removed from the second fixed bed reactor hydrotreatment catalyst.

11. A process according to claim 10 wherein during step (iii), step (i) is repeated.

12. A process according to claim 1 wherein the one or more ammonium salts is selected from ammonium halides and mixtures thereof.

13. A process according to claim 1 wherein the hydrotreatment catalyst converts at least one of furfural, furans, aldehydes, ketones and acids, into alcohols, and/or converts carbonyls into alcohols.

14. A process according to claim 1 wherein the hydrotreatment catalyst hydrogenates at least one of conjugated diolefins and styrene homologues.

15. A process according to claim 1 wherein the hydrotreatment catalyst comprises an active metal selected from the group comprising Mo, Ni, W, Pt, Pd, Cu, Fe, Zn and Ru based catalysts and combinations thereof.

16. A process according to claim 15 wherein the active metal is present in sulphided form or wherein the active metal is present in elemental form.

17. A process plant configured for carrying out the process according to claim 1.

18. A process according to claim 1, wherein the fluid is water or an aqueous solution.
